(19) United States
(12) Patent Application Publication
(10) Pub. No.: US 2018/0203415 A1
(43) Pub. Date: Jul. 19, 2018

(54) WRISTWATCH

(71) Applicant: Mule Studio Ltd., London (GB)

(72) Inventor: Jack Munro, London (GB)

(21) Appl. No.: 15/867,286

(22) Filed: Jan. 10, 2018

(30) Foreign Application Priority Data
Jan. 12, 2017 (GB) GB1700551.3

(51) Int. Cl. G04B 37/00

(52) U.S. Cl. CPC G04B 37/005; G04B 19/283

(57) ABSTRACT

A watch comprises a wristwatch casing having a front surface with pivot; a mechanism enclosed within the casing including a magnetic hand positioned to rotate in the casing proximal to the front surface; a face including at least one marker for visually indicating the time and a magnetic element; and a bezel disposed above the face and extending towards the front surface to cover the side walls of the face and part of the side walls of the casing, in which the face is supported by the upper surface of the casing, being rotationally mounted to the pivot and retained by the bezel, the front surface is between the magnetic hand of the mechanism and the face, and the magnetic hand of the mechanism guides the face via the magnetic element of the face.

### REFERENCE TO RELATED APPLICATION

This application claims priority from Great Britain Patent Application No. GB1700551.3, filed Jan. 12, 2017, the entire content of which is incorporated herein by reference.

### FIELD OF THE INVENTION

The present invention relates to a wristwatch.

### BACKGROUND TO THE INVENTION

Wristwatches are ubiquitously used to tell the time. A conventional wristwatch comprises a fixed face with markings and a pair of moving hands, disposed in front of the fixed face. The position of the hands relative to the markings on the fixed face provides a visual means of telling the time.

In order to permit accurate determination of the time, the hands must be small, and are therefore delicate. This makes them susceptible to damage, for example breaking or bending, as a result of impacts. Such impacts are frequent due to the exposed location of the watch on the wrist.

Additionally, the calibration of the mechanism may be altered, or the mechanism damaged, by unintentional forced movement of the hands. For example, if the hand were to be forced in a direction contrary to its usual course of movement, a large force would be applied to the internal mechanics of the watch movement and cause damage.

To protect the hands and mechanism from damage and unintentional movement, a glass or clear plastic case is commonly provided to cover the face and hands while permitting visual apprehension of their position.

The presence of the hands and the glass case in front of the face of the watch mean that it is not possible to easily remove and replace the watch face. This limits the customisability of the watch. Also, whilst the glass or plastic case protects the hands and face from damage, it is itself susceptible to cracking and scratching.

It is an object of the present invention to reduce or substantially obviate these problems by providing a wristwatch in which a glass case is not required to prevent damage to the hands and mechanism of the watch, and which has a removable and interchangeable face to allow customisation and easy replacement in case of damage.

### SUMMARY OF THE INVENTION

According to the present invention there is provided a watch comprising a wristwatch casing having a front surface with a pivot; a mechanism enclosed within the casing including a magnetic hand positioned to rotate inside the casing proximal to and behind the front surface; a face including at least one marker for visually indicating the time and a magnetic element; and a bezel removably attached to the casing and disposed around the face and extending over a periphery of the face, in which the face is supported by the front surface of the casing, the face being rotationally mounted to the pivot and retained by the bezel, the front surface is between the magnetic hand of the mechanism and the face, and the magnetic hand of the mechanism guides the face via the magnetic element of the face.

The mechanism determines the time and moves the magnetic hand near the front surface. The magnetic hand attracts the magnetic element of the face through the front surface, rotationally coupling the face and the hand.

The bezel holds the face to the front surface while permitting free rotation of the face about the pivot. The position of the face relative to the bezel provides a visual output of the time.

Advantageously, the hand of the watch is not exposed, but is hidden below the front surface, and there is no mechanical connection between the mechanism and the face, rather, the connection is magnetic. This allows the face to be exposed, because a glass or clear plastic case is not required to protect the hand from damage.

The magnetic attraction between the hand and the magnetic element of the face is weaker than the mechanical connections of the hand and mechanism. Advantageously, this ensures that a forced movement of the face will not force movement of the mechanism, as the magnetic connection will break before the mechanism or hand is damaged.

It should be understood that, of the magnetic hand and magnetic element, it is only necessary for one to be a magnet, in which case it is sufficient that the other be a piece of ferromagnetic metal. However, it is also possible that both hand and element should be magnets.

This arrangement also allows the face to be provided interchangeably, as the face may be conveniently detached from the casing without tools by removing the bezel and lifting the face away from the front surface and off of the pivot, then inserting another face and replacing the bezel.

The casing may be substantially cylindrical. This provides a housing for rotating components, such as the hands, without wasting space or materials. A first end of the cylinder forms a front wall and a second end of the cylinder forms a back wall, which contacts a user's arm in use. A curved side wall of the cylinder connects the front and back walls. The cylindrical casing is hollow so that the front wall has an inner surface, which faces the mechanism, in addition to the front surface. The front wall is thin and the magnetic hand is close to the front wall so that magnetic attraction through the front wall between the magnetic hand and the magnetic element of the face is substantially unimpeded.

The bezel may include a substantially cylindrical portion of internal diameter substantially equal to the diameter of the casing for receiving the casing. This allows the bezel to fit snugly over the casing and be retained on the curved side wall of the casing.

The bezel may include an annular lip for holding the face to the casing. This allows the face to be retained on the casing, specifically on the pivot and front surface of the casing, while allowing the face to rotate, being driven by the mechanism to tell the time.

The bezel may include at least one pin on an inside face of the cylindrical portion, and the casing may include at least one L-shaped groove on the curved side wall, the or each L-shaped groove being for receiving a respective pin. This allows convenient attachment and detachment of the bezel to the casing by rotation of the bezel relative to the casing. Advantageously, the face may thus be accessed and removed conveniently without tools.

The casing may include at least one spring plunger in the curved side wall facing outwards, and the bezel may include at least one corresponding indent on the curved interior surface of the cylindrical portion. The spring plungers engage with the indents to rotationally fix the bezel relative to the casing while allowing the bezel to be rotated when sufficient force is applied to depress the spring plunger so that the bezel can be removed from the casing.

The bezel may include markings for visually indicating the time. The time is shown by the position of the marking on the face relative to the marking on the bezel. This allows more rapid and accurate visual apprehension of the time.

The face may include a jewel bearing for receiving the pivot. This allows the face to rotate on the pivot when driven by the magnetic engagement with the hand with minimal friction and wear.

The face may include a face layer for visual apprehension and a face backing for engagement with the mechanism. This allows an aesthetically superior material, for example polished granite, to be used, while minimising material costs and the weight of the watch, and allows the jewel bearing and other features to be attached to a more easily machined material for ease of manufacture.

The face layer may include a notch and the face backing may include a corresponding protrusion for reception in the notch, so that the marking is provided by the protrusion. The visual contrast between the different materials of the face layer and the face backing then provides the marking. This provides an aesthetically desirable effect and a convenient method of manufacture.

The face or face layer may be made of stone, metal, glass, wood or a plastics material. Multiple interchangeable faces may be provided. This allows the appearance of the watch to be customised.

### BRIEF DESCRIPTION OF THE DRAWING

For a better understanding of the present invention, and to show more clearly how it may be carried into effect, reference will now be made by way of example only to the accompanying drawing, in which:

FIG. 1 shows an exploded perspective view of a watch.

### DETAILED DESCRIPTION OF THE INVENTION

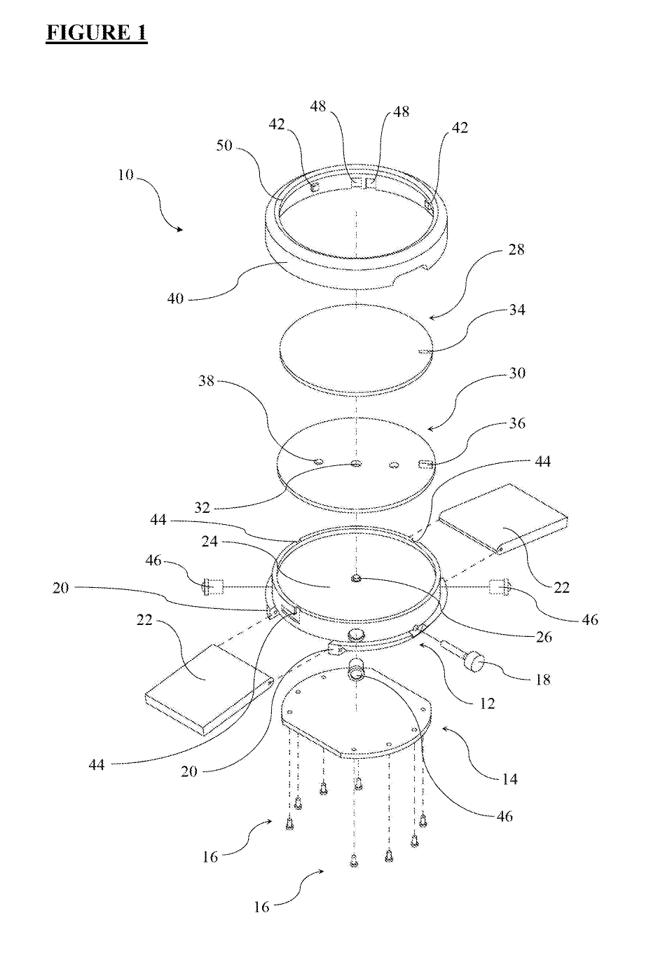

Referring to FIG. 1, an embodiment of the wristwatch is indicated generally at 10. The wristwatch includes a casing 12, within which is housed a time keeping mechanism (not shown). The casing 12 is substantially cylindrical. A removable casing back 14 provides a bottom surface of the casing 12. The removable casing back 14 is a flat sheet of metal, and is secured to the casing 12 by a plurality of screws 16. In this embodiment, there are eight screws 16. The casing back 14 can be removed to change a battery in a battery powered mechanism.

The casing 12 includes two pairs of lugs 20. The pairs of lugs 20 are disposed on opposite sides of the casing 12. Each pair of lugs 20 receives a spring bar (not shown). A strap 22 is also provided for securing the wristwatch to the wrist of a user. An end of the strap 22 passes around each spring bar.

The casing also includes a crown 18. The crown 18 protrudes from the cylindrical side wall of the casing and allows the time told by the time keeping mechanism to be set.

A front surface 24 of the casing 12 is circular and flat. The front surface 24 includes a centrally disposed pivot 26.

The wristwatch also includes a face layer 28 and a face backing 30. The face layer 28 and the face backing 30 are both circular. The face backing 30 includes a centrally disposed jewel bearing 32. The face backing 30 is supported by the upper surface 26 and is concentric with the upper surface 26 so that the jewel bearing 32 engages the pivot 26, allowing the face backing 30 to rotate on the casing 12.

The face layer 28 is substantially the same size and shape as the face backing 30. The face layer 28 sits atop the face backing 30 and is supported by the face backing 30 concentric with the face backing 30. The face layer includes a notch 34. The notch 34 engages a protrusion 36 on the face backing 30. This joins the face layer 28 and the face backing 30 and ensures that they rotate together.

The face backing 30 includes a magnetic element 38. The magnetic element 38 is attracted to a magnetic hand (not shown) of the mechanism. This causes the face backing 30 and the face layer 28 to rotate with the magnetic hand so that the time may be visually ascertained from the position of the face.

A bezel 40 is also provided. The bezel 40 comprises a hollow cylindrical portion of internal diameter substantially equal to the diameter of the casing 18. The internal face of the hollow cylindrical portion includes at least one pin 42. In this embodiment four pins 42 are provided. The pins 42 are equally spaced around the circumference of the bezel 12.

The casing 12 includes three L-shaped slots 44. Each pin 42 releasably engages with one of the L-shaped slots 44 in the casing 12.

The casing 12 also includes four spring plungers 46 (one not shown). The spring plungers 46 are disposed on opposite sides of the casing 12. The internal face of the hollow cylindrical portion further includes a plurality of recesses 48. The recesses 48 releasably engage the spring plungers 46 when each pin 42 is disposed at a distal end of a horizontal portion of an L-shaped slot 44. This secures the bezel 40 rotationally relative to the casing 12.

The bezel 40 also includes an annular lip 50. The annular lip 50 extends inwardly from the upper edge of the cylindrical portion of the bezel 40.

A plurality of interchangeable faces 28 is provided.

In use, a face layer 28 is selected based on aesthetic preferences of the user. The face layer 28 is placed on the face backing 30 so that the notch 34 of the face layer 28 engages the protrusion 36, rotationally coupling the face layer 28 to the face backing 30. The assembled face layer 28 and face backing 30 are placed on the casing 12 so that the pivot 26 engages the jewel bearing 32.

In other embodiments, the face layer might be permanently bonded to the face backing so that both are replaced together. If a plurality of interchangeable faces is provided, each face may comprise a permanently bonded face layer 28 and face backing 30, a detachable face layer 28 and face backing 30, or an integrally formed face.

The bezel 40 is then placed over the face layer 28, face backing 30 and casing 12. The bezel 40 is orientated relative to the casing 12 so that the pins 42 are above the vertical portions of the L-shaped slots 44. The bezel 40 is lowered so that the pins 42 move in to the vertical portions of the L-shaped slots 44 and rotated in a clockwise direction (in this embodiment) so that the pins 42 move to the distal ends of the horizontal portions of the L-shaped slots 44. The sides of the face layer 28, face backing 30 and casing 12 are hidden by the sides of the bezel. The annular lip 50 covers a periphery of the face layer 28 so that the face layer 28 and face backing 30 are restrained.

The face 28 and face backing 30 are orientated so that the magnet 38 is above the magnetic hand of the time keeping mechanism (not shown). It will be understood that the face layer 28 and face backing 30 will naturally move to this orientation by action of the magnetic element 38 and magnetic hand if permitted. The magnetic hand of the time keeping mechanism moves as time passes, and the attraction between the magnet 38 and the magnetic hand causes the face backing 30 and face 28 to rotate correspondingly. This changes the position of the notch 34 relative to the bezel 40.

In use, if the face is knocked, the magnetic attraction between the hand and the magnetic element of the face breaks because it is weaker than the hand or mechanism. The face then rotates freely on the pivot until it has lost enough kinetic energy through friction to be recaptured by magnetic attraction to the hand, at which point its position once more indicates the correct time.

The components are arranged so that when the time keeping mechanism tells the time as 12:00, the notch 34 is disposed exactly mid-way between the lugs of one of the pairs of lugs 20, as on a conventional watch.

These embodiments are provided by way of example only, and various changes and modifications will be apparent to persons skilled in the art without departing from the scope of the present invention as defined by the appended claims.

1. A wristwatch comprising:
a wristwatch casing having a front surface with a pivot;
a mechanism enclosed within the casing including a magnetic hand positioned to rotate inside the casing proximal to and behind the front surface;
a face including at least one marker for visually indicating the time and a magnetic element; and
a bezel removably attached to the casing disposed around the face and extending over a periphery of the face, in which the face is supported by the upper surface of the casing, the face being rotationally mounted to the pivot and retained by the bezel, the front surface is between the magnetic hand of the mechanism and the face, and the magnetic hand of the mechanism guides the face via the magnetic element of the face.

2. A wristwatch as claimed in claim 1 in which the casing is substantially cylindrical, ends of the cylinder forming a front wall and a back wall, and a curved side wall of the cylinder connecting the front wall to the back wall.

3. A wristwatch as claimed in claim 2 in which the bezel includes a substantially cylindrical portion of internal diameter substantially equal to the diameter of the casing for receiving the casing.

4. A wristwatch as claimed in claim 1 in which the bezel includes an annular lip for holding the face to the casing.

5. A wristwatch as claimed in claim 3 in which the bezel includes at least one pin on an inside face of the cylindrical portion, and the casing includes at least one L-shaped groove on the curved side wall, the or each L-shaped groove being for receiving a respective pin.

6. A wristwatch as claimed in claim 1 in which the bezel includes markings for visually indicating the time.

7. A wristwatch as claimed in claim 1, in which the face includes a jewel bearing for receiving the pivot.

8. A wristwatch as claimed in claim 1 in which the face includes a face layer for visual apprehension and a face backing for engagement with the mechanism.

9. A wristwatch as claimed in claim 8, in which the face layer includes a notch and the face backing includes a corresponding protrusion for reception in the notch, so that the marking is provided by the protrusion.

10. A wristwatch as claimed in claim 1 in which the face or face layer is made of stone.

11. A wristwatch as claimed in claim 1 in which the face or face layer is made of metal.

12. A wristwatch as claimed in claim 1 in which the face or face layer is made of glass.

13. A wristwatch as claimed in claim 1 in which the face or face layer is made of wood.

14. A wristwatch as claimed in claim 1 in which the face or face layer is made of a plastics material.
